(19) United States
(12) Patent Application Publication
(10) Pub. No.: US 2010/0225884 A1
(43) Pub. Date: Sep. 9, 2010

(54) VEHICLE INSTRUMENT PANEL WITH PROJECTOR

(75) Inventor: Ju Hyun Kim, Gwangju (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/623,860

(22) Filed: Nov. 23, 2009

(30) Foreign Application Priority Data
Mar. 4, 2009 (KR) KR10-2009-0018453

(51) Int. Cl. G03B 21/28

(52) U.S. Cl. 353/14

(57) ABSTRACT

A vehicle instrument panel with a projector is provided. The vehicle instrument panel with a projector includes a screen displaying an image, a projector module irradiating the image onto the screen, and a printed circuit board (PCB) outputting a signal for controlling the projector module, wherein the projector module includes a case, a projector installed inside the case to irradiate the image onto the screen, and a reflector reflecting the image projected from the projector to the screen. Since the projector and the screen stand close to each other at maximum and the image projected from the projector is irradiated onto the screen using the reflector, the irradiation distance and the size of the displayed image is greatly extended, and thus the driver's visibility is improved to be helpful to safe driving. Also, the generation of electromagnetic waves is greatly reduced, and thus no separate electromagnetic shielding design is required.

### CROSS-REFERENCE TO RELATED APPLICATION

This application is based on and claims priority from Korean Patent Application No. 10-2009-0018453, filed on Mar. 4, 2009 in the Korean Intellectual Property Office, the disclosure of which is incorporated herein in its entirety by reference.

### BACKGROUND OF THE INVENTION

### Field of the Invention

The present invention relates, generally, to a vehicle instrument panel with a projector, and more particularly, to a vehicle instrument panel with a projector, which can suitably increase the size of an image to be displayed without the necessity of electromagnetic shielding design.

Generally, a vehicle instrument panel, which is called a cluster gauge, is an instrument panel that suitably informs a driver of the whole traveling state of a vehicle, and the driver can recognize the traveling state through viewing of the vehicle instrument panel at any time as the driver observes the forward area of the vehicle.

Accordingly, in the vehicle instrument panel, sensors sense a vehicle speed, an RPM, a flow rate, and the like, and suitably change the positions of gauge needles. Preferably, the driver confirms the state information of the vehicle being driven through reading of figures indicated by the needles, and then suitably adjusts the speed of the moving vehicle with reference to the confirmed state information.

FIG. 1 is an exemplary sectional view illustrating the inside of a conventional vehicle instrument panel.

Preferably, the conventional vehicle instrument panel, as illustrated in FIG. 1, includes a lower case 10, a printed circuit board (PCB) 20, a cable 40 for suitably transmitting control signals outputted from the PCB 20 to a support module 30, a step motor 60 for moving a pointer 50, a projector module 70 for suitably receiving an image signal of the support module 30, and a screen 80 for suitably displaying an image projected from the projector module 70 thereon.

According to the conventional vehicle instrument panel as constructed above, the image projected from the projector module 70 is directly irradiated onto the screen 80, and the driver confirms the figures indicated by the pointer 50 through the image irradiated onto the screen 80.

However, in the conventional vehicle instrument panel, the size and the shape of the screen 80 are pre-fixed, and thus it is possible to display only an image of which the size is limited in accordance with the pre-fixed size and shape. Also, the distance between the projector module 70 and the screen 80 is too short to implement the screen with a size of three inches or more.

Further, since the projector module 70 and the PCB 20 are far apart from each other to suitably extend the size of the image to be displayed on the screen, a separate support module 30 for suitably connecting the projector module 70 and the PCB 20 is additionally required.

In addition, a cable 40 for connecting the projector module 70 and the PCB 20 is lengthened to cause a considerable number of electromagnetic waves to be generated, and thus a separate electromagnetic protection socket is installed for shielding the electromagnetic waves.

The above information disclosed in this the Background section is only for enhancement of understanding of the background of the invention and therefore it may contain information that does not form the prior art that is already known in this country to a person of ordinary skill in the art.

### SUMMARY OF THE INVENTION

to the present invention, in one aspect, provides a vehicle instrument panel with a projector, which can suitably increase the size of an image to be displayed. The vehicle instrument panel of the present invention, in preferred embodiments, does not require installation of a separate support module and an electromagnetic shielding socket by making the projector and the screen stand close to each other at maximum, and irradiation of an image projected from the projector onto a screen using a reflector.

The present invention, in preferred embodiments, provides a vehicle instrument panel with a projector, according to an embodiment of the present invention, which includes a screen displaying an image; a projector module suitably irradiating the image onto the screen; and a printed circuit board (PCB) suitably outputting a signal for controlling the projector module; wherein the projector module includes a case, a projector suitably installed inside the case to irradiate the image onto the screen, and a reflector suitably reflecting the image projected from the projector to the screen.

Preferably, the PCB may include a graphics chip suitably adjusting the shape and the size of the image being displayed on the screen.

In other preferred embodiments, the projector module may adjust the size of the image in accordance with the distance between the projector and the reflector.

Preferably, the size of the image projected from the projector module may be suitably reduced as the distance between the projector and the reflector becomes shorter, whereas the size of the image may be suitably increased as the distance becomes longer.

In certain preferred embodiments, the reflector may have an inclined angle so as to reflect the image projected from the projector to the screen.

Preferably, the projector may be suitably mounted on an upper part of the PCB, and the PCB and the projector may be suitably connected through a cable.

According to preferred embodiments of the invention, with the above-described construction, since the projector and the screen stand suitably close to each other at maximum and the image projected from the projector is suitably irradiated onto the screen using the reflector, the irradiation distance and the size of the displayed image is greatly extended, and thus the driver's visibility is improved to be helpful to safe driving. Further, the generation of electromagnetic waves is greatly reduced, and, preferably, in further exemplary embodiments, no separate electromagnetic shielding design is required.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating an exemplary conventional vehicle instrument panel with a projector; and

FIG. 2 is a sectional view illustrating a vehicle instrument panel with a projector according to another preferred embodiment of the present invention.

### DETAILED DESCRIPTION

As described herein, the present invention features a vehicle instrument panel with a projector, comprising a screen displaying an image, a projector module irradiating the image onto the screen, and a printed circuit board (PCB) outputting a signal for controlling the projector module.

In one embodiment, the projector module further comprises a case, a projector installed inside the case, and a reflector.

In another embodiment, the projector irradiates the image onto the screen.

In another further embodiment, the reflector reflects the image projected from the projector to the screen.

The invention also features a motor vehicle comprising the vehicle instrument panel of any one of the above aspects.

Hereinafter, preferred embodiments of the present invention will be described in greater detail with reference to the accompanying drawings.

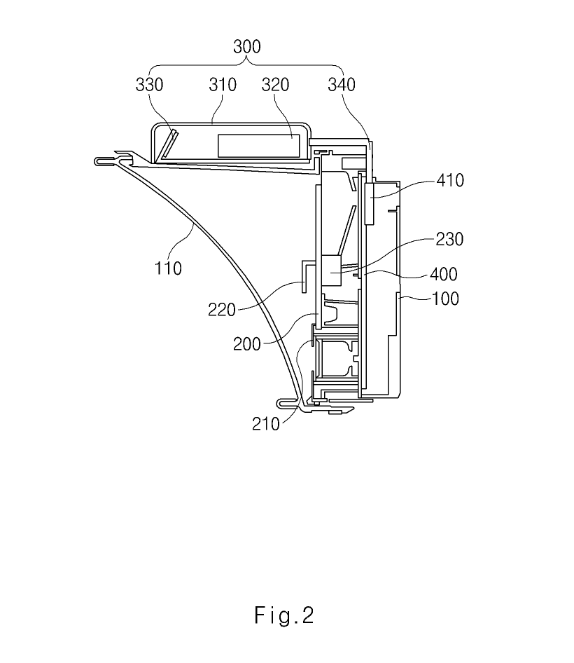

An exemplary vehicle instrument panel according to preferred embodiments of the present invention is shown in FIG. 2. FIG. 2 is a sectional view illustrating a vehicle instrument panel with a projector.

As illustrated in FIG. 2, the vehicle instrument panel with a projector according to an exemplary embodiment of the present invention is provided with a reflector 330 formed in a body with a projector module 300. Preferably, the irradiation distance between the projector module 300 and a screen 200 is suitably extended by the reflector 330, and thus an image to be displayed on the screen 200 through the reflector 330 can be expanded over 7 inches.

Preferably, the vehicle instrument panel with a projector according to an exemplary embodiment of the present invention includes a lower case 100, the screen 200 suitably displaying an image, the projector module 300 suitably irradiating the image onto the screen 200, and a printed circuit board (PCB) 400 on which a graphics chip 210 that transfers an image signal to the projector module 300 is suitably mounted.

In one preferred embodiment, the lower case 100 is to mount the vehicle instrument panel in front of the driver's seat, and the front part of the lower case 100 is suitably engaged with a transparent or semi-transparent window acryl 110.

Here, the lower case 100 has the same construction and function as the conventional lower case, and thus the detailed description thereof will be omitted.

According to further preferred embodiments, the image projected from the projector module 300 is suitably displayed on the screen 200 that is provided in front of the lower case 100. Preferably, a character board 210 is suitably mounted along the outer periphery of the screen 200, and a pointer 220 for indicating the character board 210 is suitably mounted in the center of the screen 200. In a related embodiment, the pointer 220 is preferably rotated by a step motor 230.

In another embodiment of the present invention, the projector module 300 is suitably provided on the upper part of the screen 200 as it is suitably arranged adjacent to the PCB 400 to irradiate the image onto the screen 200 through a reflector 330. Preferably, the projector module 300 includes, but may not be limited only to, a projector case 310, a projector 320, an anti-vibration pad (not illustrated), and a cable 340.

Preferably, in certain embodiments, the projector module 300 includes the projector case 310 provided on the upper part of the PCB 400, the projector 320 installed inside the projector case 310, the reflector 330 arranged in front of the projector 320 to suitably reflect the image projected from the projector 320 to the screen 200, the anti-vibration pad attached to a corner part where the projector 320 and the projector case 310 are in contact with each other to absorb impact, and the cable 340 transferring control signals from the PCB 400 to the projector 320.

In further exemplary embodiments, it is preferable that the projector 320 has a compact size so that the projector can be easily installed inside the vehicle instrument panel.

Preferably. the reflector 330 is suitably arranged in front of the projector 320 with the same height as the projector 320, and has an inclined angle toward the screen 200.

Accordingly, the reflector 330 suitably reflects the image projected from the projector 320 to the screen 200. The image from the projector 320 is primarily expanded as it is irradiated onto the reflector 330, and then is secondarily expanded as it is reflected to the screen 200 by the reflector 330.

In further related embodiments, it is preferable that a mirror is used as the reflector 330.

Preferably, the projector module 300 can suitably adjust the size of the image irradiated onto the screen 200 in accordance with the distance between the projector 320 and the reflector 330.

Accordingly, the size of the image which is irradiated onto the screen 200, is suitably reduced as the distance between the projector 320 and the reflector 330 becomes shorter, while the size of the image is suitably increased as the distance between the projector 320 and the reflector 330 becomes longer.

Preferably, the inclination of the reflector 330 is changed in accordance with the adjustment of the distance between the projector 320 and the reflector 330, and the image from the projector 320 is irradiated onto the screen 200 accordingly.

In further preferred embodiments, according to the projector module 300 as described herein, since the image from the projector 320 is not directly irradiated onto the screen 200, but is irradiated onto the screen 200 via the reflector 330, the image can be suitably expanded as much as the increased irradiation distance, and thus it is possible to expand the displayed image over 7 inches.

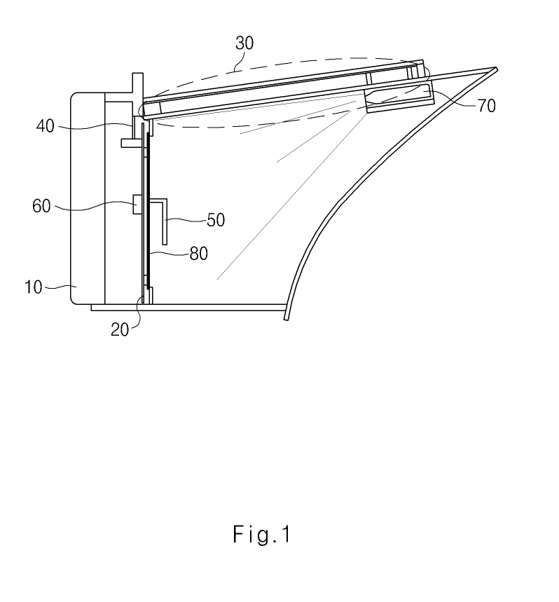

Further, since the distance between the projector module 300 and a graphics chip 410 becomes shorter as the projector module 300 is arranged adjacent to the graphics chip 410, the length of the cable 340 can be considerably reduced, and the installation of a separate support module (See FIG. 1) and an electromagnetic protection socket can be removed with the cost for electromagnetic shielding design reduced.

Preferably, the PCB 400 is provided on the rear surface of the screen 200, to control the states of vehicle speed, flow rate, cooling water temperature, and the like. In further preferred embodiments, the PCB 400 preferably includes the graphics chip 410 that adjusts the shape and the size of the image being displayed on the screen 200.

Accordingly, the PCB 400 includes a controller, a memory, the graphics chip 410, and a decoder.

Preferably, the controller controls the driving of the vehicle instrument panel, a warning lamp, a graphic image, and the like, in accordance with control signals being applied from an outside.

Preferably, the memory stores graphic content, sound source content, and the like.

Preferably. the graphics chip 410 provides images by function keys (e.g. traveling, stopping, audio on/off, and the like) through selection of graphic content stored in the memory, and suitably provides photographing data, which is received from a camera installed on the outside of the vehicle, through the decoder.

In further preferred embodiments, the graphics chip 410 outputs control signals for adjusting the size of the image (e.g. three to eight inches) and the shape of the image (e.g. circle, semi-circle, square, rectangle, and the like). The output control signals are suitably transferred to the projector 320 through the cable 340.

In further preferred embodiments, the decoder decodes and transmits analog data, which is suitably received from the camera (not illustrated) installed on the outside of the vehicle, to the graphics chip 410.

The operation of the vehicle instrument panel with a projector as constructed above according to an exemplary embodiment of the present invention is described herein.

In a first embodiment, first a driver connects the power supply to the vehicle.

In a further related embodiment, the graphics chip 410 provided on the PCB 400 suitably transfers an image signal to the projector 320 of the projector module 300 through the cable 340, and the projector 320 irradiates the transferred image signal onto the reflector 330 to primarily expand the image. Preferably. the reflector 330 then irradiates the primarily expanded image onto the screen 200 to secondarily expand the image.

Accordingly, the image can be greatly expanded in accordance with the irradiation distance through the projector 320, the reflector 330 and the screen 200, and the size of the image can be suitably extended over 7 inches by increasing the distance between the projector 320 and the reflector 330.

In another preferred embodiment, since the projector 320 is suitably arranged adjacent to the graphics chip 410 on the upper surface of the PCB 400, the length of the cable 340 for connecting the projector 320 and the graphics chip 410 can be suitably reduced, and a separate support module for mounting the projector module 300 thereon can be suitably removed.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A vehicle instrument panel with a projector, comprising:
a screen displaying an image;
a projector module irradiating the image onto the screen; and
a printed circuit board (PCB) outputting a signal for controlling the projector module;
wherein the projector module includes a case, a projector installed inside the case to irradiate the image onto the screen, and a reflector reflecting the image projected from the projector to the screen.

2. The vehicle instrument panel of claim 1, wherein the PCB comprises a graphics chip adjusting the shape and the size of the image being displayed on the screen.

3. The vehicle instrument panel of claim 1, wherein the projector module adjusts the size of the image in accordance with the distance between the projector and the reflector.

4. The vehicle instrument panel of claim 3, wherein the size of the image projected from the projector module is reduced as the distance between the projector and the reflector becomes shorter, whereas the size of the image is increased as the distance becomes longer.

5. The vehicle instrument panel of claim 1, wherein the reflector has an inclined angle so as to reflect the image projected from the projector to the screen.

6. The vehicle instrument panel of claim 1, wherein the projector is mounted on an upper part of the PCB, and the PCB and the projector are connected through a cable.

7. A vehicle instrument panel with a projector, comprising:
a screen displaying an image;
a projector module irradiating the image onto the screen; and
a printed circuit board (PCB) outputting a signal for controlling the projector module.

8. The vehicle instrument panel of claim 7, wherein the projector module further comprises a case, a projector installed inside the case, and a reflector.

9. The vehicle instrument panel of claim 8, wherein the projector irradiates the image onto the screen.

10. The vehicle instrument panel of claim 8, wherein the reflector reflects the image projected from the projector to the screen.

11. A motor vehicle comprising the vehicle instrument panel of claim 1.

12. A motor vehicle comprising the vehicle instrument panel of claim 7.
